(19) United States
(12) Patent Application Publication
(10) Pub. No.: US 2026/0071517 A1
(43) Pub. Date: Mar. 12, 2026

(54) METHOD FOR INFERRING WELL INTEGRITY CRITERIA

(71) Applicant: SHELL USA, INC., Houston, TX (US)

(72) Inventors: Ligang LU, Houston, TX (US); Jie CHEN, Houston, TX (US); Ilyana FOLMAR, Houston, TX (US); Mohamed SIDAHMED, Rio de Janeiro (BR); Zexuan DONG, Houston, TX (US); Qiushuo SU, Houston, TX (US)

(21) Appl. No.: 19/106,294

(22) PCT Filed: Sep. 14, 2023
(86) PCT No.: PCT/US2023/074160

§ 371 Date: Feb. 25, 2025

Related U.S. Application Data
(60) Provisional application No. 63/407,342, filed on Sep. 16, 2022.

(51) Int. Cl. E21B 41/00; G06N 3/084

(52) U.S. Cl. CPC E21B 41/0064; G06N 3/084; E21B 2200/22

(57) ABSTRACT

A method for inferring a well integrity criterion used for a CO2 storage site risk assessment of a subterranean formation uses a training well data set having a set of associated training labels. A backpropagation-enabled process is dependency-trained to identify contextual relationships between elements of the training well data set. The dependency-trained backpropagation-enabled process is label-trained using the training well data set and the associated training labels to assess a training well integrity criterion. The label-trained backpropagation-enabled process is used to compute a well integrity criterion in a non-training well data set.

### FIELD OF THE INVENTION

The present invention relates to a method for inferring well integrity criteria from well data, and, in particular, for inferring well integrity criteria that can be used for a CO₂ storage site risk assessment of a subterranean formation.

### BACKGROUND OF THE INVENTION

The increased demand for energy resulting from worldwide economic growth and development has contributed to an increase in concentration of greenhouse gases (GHG) in the atmosphere. This has been regarded as one of the most important challenges facing humankind in the 21st century. To mitigate the effects of GHG, efforts have been made to reduce the global carbon footprint.

Efforts to mitigate the release of GHG have led to a variety of technologies such as CCUS or CCS (Carbon Capture, Utilization and Sequestration, or Carbon Capture and Storage). With respect to geologic sequestration, efforts have been directed towards injecting gaseous or supercritical CO₂ into a subsurface formation.

The use of depleted hydrocarbon reservoirs has been considered for CO₂ storage. Depleted oil and gas reservoirs are suitable locations for sequestering CO₂ owing to their rock and structural properties and access to required infrastructure. In particular, abandoned wells in these reservoirs can be used for injecting CO₂ without investing in drilling new wells saving both time and cost.

CCS is currently constrained by the availability of sufficient de-risked pore space for safe storage. Depending on the type of geological storage in saline aquifers or depleted hydrocarbon bearing formations, multiple pathways could exist for CO₂ migration. It is important to understand the integrity of a well for assessing risk associated with CO₂ containment. In particular, it is important to determine the likelihood of undesirable leakage of CO₂ into unwanted areas, such as groundwater zones.

Well integrity can be determined from legacy well documentation. However, wells in depleted reservoirs were often drilled decades ago and documentation may not be standardized. Furthermore, the documentation was focused on parameters for the operation at the time, without a view to future use as a CCS site.

Accordingly, significant effort is required from a subject matter expert to identify relevant information for generating a CO₂ storage site risk assessment, which often results in longer lead times, for example, up to a year, for a CO₂ sequestration site to mature.

One challenge in the well integrity evaluation is identification of potential CO₂ migration paths of fluids out of the storage complex. Depending on the areal location and the depth of penetration, legacy wells may be exposed to CO₂ plume and/or elevated bottomhole pressure due to the lifted formation brine (if CO₂ stored in a saline aquifer) propagating from CO₂ injection wells. Another challenge for injecting CO₂ into the depleted reservoir is related to CO₂ phase behavior. Expansion of CO₂ may lead to very low temperatures in the well, posing limitations on well design, integrity, and operability, and injectivity as hydrates may form. Alternatively, in case of a strong aquifer, water backfills the porous formation after the hydrocarbons are produced from the reservoir. Accordingly, a significant pressure is required for injecting CO₂ to overcome the water pressure in the formation and limited capacity is available for storage without potential risking caprock integrity. Compression of the gas requires energy with a related GHG footprint.

Another challenge facing well integrity evaluation is the nature of geological stratigraphy and lithology along the wellbore. CO₂ is light i.e., less dense than water, and will naturally travel upward because of buoyancy. Loss of containment or vertical migration of the fluids from the storage complex may be possible in wells penetrating the main seal (caprock). Therefore, the formation should have a high-quality seal to avoid leak paths that could result in release into the environment. When upward mobility is limited, CO₂ will then migrate laterally potentially encountering additional leaks paths related to lack of closure, faults, or improperly abandoned wells. This presents limitations of where CO₂ can be responsibly injected and necessitates extensive CO₂ monitoring activities for a prolonged period to ensure the CO₂ remains in the subsurface formation.

There remains a need for reducing the lead time in maturing a site for CO₂ injection could result in faster CCS project delivery timelines for achieving net-zero targets, whilst improving accuracy of a CO₂ storage site risk assessment.

### SUMMARY OF THE INVENTION

According to one aspect of the present invention, there is provided a method for inferring a well integrity criterion used for a CO₂ storage site risk assessment of a subterranean formation, comprising the steps of: providing a training well data set, the training well data set having a set of associated training labels; dependency-training a backpropagation-enabled process to identify contextual relationships between elements of the training well data set, thereby producing a dependency-trained backpropagation-enabled process; label-training the dependency-trained backpropagation-enabled process using the training well data set and the associated training labels to assess a training well integrity criterion, thereby producing a label-trained backpropagation-enabled process; and using the label-trained backpropagation-enabled process to compute a well integrity criterion in a non-training well data set.

### DETAILED DESCRIPTION OF THE INVENTION

The present invention provides a method for inferring a well integrity criterion that can be used for a CO₂ storage site risk assessment of a subterranean formation.

As noted above, depleted oil and gas reservoirs have been considered for storing CO₂ because they have desirable structural features, in particular, seal and trap structures to hold CO₂ for long periods of time. Further, the sites often have infrastructure such as pipelines, and accessibility to roadways that can be reused for CCS sites. Abandoned wells drilled in these reservoirs can be used to inject CO₂ but because the wells may have been drilled from years to decades ago, a well integrity evaluation is important before making any injection plans.

Analysis of well data is important for improving efficiency and accuracy of risk assessment for CCS sites. Well integrity evaluation involves doing a risk assessment by understanding a criterion, such as, without limitation, rock-to-rock isolation, cement bonding, casing, isolation of permeable zones, and isolation of groundwater zones. Verification is done through the evidence of present cement plugs and thickness, cemented casings, squeezed perforations in the wells, and combinations thereof.

However, when considering the use of an abandoned well, the well data may be decades old. Also, because the well data was generated for a different purpose, the well data is typically not set up in a standardized form for answering a well integrity query for purposes of CCS. For example, the well data may include, such as, for example, without limitation, daily drilling reports, cementing reports, well completion reports, workover reports, abandonment reports, general well data, pressure tests, mud record, information about cores taken, geological reports, abandonment or plug back, casing or liner data, cement data, and/or daily work summary. Other data may include the depth of groundwater zone.

However, well data is often voluminous and often available in non-searchable pdf and/or image files. For example, the information may be present in hundreds of pages for one well, often including handwritten notes, combined with typeset. For example, a report may have been completed by handwriting on a typeset form. Alternatively, or in addition, reports may be in tabular form with numerical values in a column having a heading several rows above the value. Often, unstandardized jargon, acronyms, and abbreviations were used in generating the original well data. As examples, a perforation may be referred to as perf, perforate, perf'd, and the like, while cement may be referred to as cmt., cement and so on. Finally, units of measure and date formats are often used interchangeably.

Moreover, well integrity criterion also often requires contextual relationships between elements of the well data.

Text extraction using a rule-based Natural Language Processing (NLP) model has been considered for filtering useful information from text. Rule-based NLP uses pre-defined rules to filter information from the text using regular expressions by reviewing the text line-by-line and generating an answer whenever there is a rule match. For example, one rule can be to search for the keyword “perforation” and return any digits nearby the keyword to generate a perforation depth. This algorithm works well on extracting information directly present in the text. However, rule-based NLP are unable to make inferences from text data. So, for example, perforation, plug, and cement depths can be determined, but there is no understanding as to whether they are squeezed, milled, or drilled. Moreover, the mention of a well operation could mean different things in different contexts. For example, squeezing could be a cement squeeze or an acid squeeze.

The present inventors have surprisingly discovered that well integrity criteria can be inferred with a high degree of accuracy from legacy well data.

In accordance with the present invention, legacy well documents are used for providing a training well data set. The training well data set has a set of associated training labels. A backpropagation-enabled process is dependency-trained to identify contextual relationships between elements of the training well data set. The dependency-trained backpropagation-enabled process is then label-trained using the training well data set and the associated training labels to assess a training well integrity criterion. The label-trained backpropagation-enabled process is used to compute a well integrity criterion in a non-training well data set.

By providing labeled domain-specific training data, relevant well information can be inferred from the legacy well data. This was not possible with conventional rule-based approaches. Using the method of the present invention, lead time for maturing a site for CO₂ injection can be reduced, resulting in faster CCS project delivery timelines and contributing to net-zero targets.

The legacy data may be provided in a searchable format. Where the legacy data is not searchable, the documents may be subjected to an OCR (optical character recognition) process, for example, without limitation, Google Tesseract OCR engine to extract raw unstructured text from pdf and/or image files.

The unstructured text may be provided to a dataframe, for example, a pandas Dataframe, to be utilized by a NLP model to retrieve requisite information about the well parameters.

An example of a suitable NLP process is T5 (Text-to-Text Transfer Transformer), as described in Raffel et al. (“Exploring the Limits of Transfer Learning with a Unified Text-to-Text Transformer” arXiv: 1910.10683; 2019).

Examples of backpropagation-enabled processes include, without limitation, artificial intelligence, machine learning, and deep learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

The backpropagation-enabled process is preferably a supervised, or semi-supervised process. In one embodiment, a supervised process is made semi-supervised by the addition of an unsupervised technique.

In a supervised backpropagation-enabled process, the training well data set is labeled to provide examples of inferences of contextual relationships and the impact of the relationship on a well integrity criterion.

The training well data set may be selected from real well data, synthetically generated well data, augmented well data, and combinations thereof.

For real well data, associated labels describing well integrity criteria in the document may be manually generated, while labels for simulated well data are automatically generated. The generation of labels, especially manual label generation, is time-intensive and requires expertise and precision to produce an effective set of labels.

By augmented data, we mean real well data and/or synthetically generated data that is modified to produce plausible or implausible alternative samples. The machine learning method involves extracting patches from input data and transforming that data based on the input data and domain knowledge to generate augmented data. Transforming data is selected from an identity transformation, a spatial filter, a temporal filter, and a resampling using interpolation or extrapolation. In another embodiment, two pieces of data are blended together to generate a new piece of data. Other augmenting methods may also be used to generate augmented data. The labels may be preserved or modified in the augmentation. In this way, the data set size may be augmented to improve the model by introducing variations of data without requiring resources of acquiring and labeling real data or generating new synthetic data. Preferably, the augmented data is generated by a test-time augmentation technique.

The backpropagation-enabled process is dependency-trained to compute contextual relationships or connections between elements of the training well data set.

The dependency-training step preferably computes contextual relationships between elements of the training well data set by applying self-attention weights to the training well data set.

The dependency-trained backpropagation-enabled process is then label-trained using the training well data set and the associated training labels to assess a training well integrity criterion.

The label-trained backpropagation-enabled process can now be used to compute a well integrity criterion in a non-training well data set.

Preferably, the label-trained backpropagation-enabled process is further trained by a validation step, a correction, and combinations thereof based on the inferred well integrity criterion produced using the non-training well data set.

### EXAMPLES

The following non-limiting examples of an embodiment of the method of the present invention as claimed herein are provided for illustrative purposes only.

A set of 73 well documents was subjected to an OCR process step to convert pdf files and/or image files into raw unstructured text documents. The raw unstructured text documents were divided into two sets-a training set and a non-training set.

The training well data was reviewed by a subject matter expert, who labelled the training well data for the desired well integrity criterion.

The Examples herein tested the accuracy of the model to assess a well integrity criterion. Specifically, the well integrity criterion was an indication of whether a well perforation was squeezed or unsqueezed.

For a Comparative Example, a pre-trained Text-to-text transformer T5 model, as described in Raffel et al. (“Exploring the Limits of Transfer Learning with a Unified Text-to-Text Transformer” arXiv: 1910.10683; 2019) was fine-tuned on the BoolQ dataset, as described by Clark et al. (“BoolQ: Exploring the Surprising Difficulty of Natural Yes/No Questions, arXiv: 1905.10044; 2019) [9] to generate Boolean responses. T5 is an encoder-decoder model pre-trained on a multi-task mixture of unsupervised and supervised tasks and for which each task is converted into a text-to-text format.

The BoolQ dataset was tested using a non-training set of well data. The non-training data set was comprised of 33 data samples.

For the Inventive Examples 1 and 2, the BoolQ dataset was supplemented with training well data. In the case of Inventive Example 1, 29 data samples were used, while 50 data samples were used in Inventive Example 2. The remainder of the 73 well documents were used as non-training well data to test the accuracy of the well integrity criterion test.

The results for the Comparative Example and the Inventive Examples are summarized in Table 1.

TABLE 1

| | Training Data | Test Data | Accuracy |
|---|---|---|---|
| Comparative | BoolQ | 33 non-training well | 28% |
| Example | | data samples | |
| Inventive | BoolQ + 29 training | 44 non-training well | 85% |
| Example 1 | well data samples | data sample | |
| Inventive | BoolQ + 50 training | 23 non-training well | 96% |
| Example 2 | well data samples | data sample | |

As shown in Table 1, the Comparative Example yielded poor results. Results of the Inventive Examples demonstrated significant improvement using the training well data.

The Examples demonstrate how the method of the present invention can be used to extract relevant information from the well documents by overcoming limitations of conventional rule-based NLP methods, for understanding well integrity criteria that can then be used for generating a CO₂ storage site risk assessment for a subterranean formation.

While preferred embodiments of the present invention have been described, it should be understood that various changes, adaptations, and modifications can be made therein within the scope of the invention(s) as claimed below.

What is claimed is:

1. A method for inferring a well integrity criterion used for a CO₂ storage site risk assessment of a subterranean formation, comprising the steps of:
providing a training well data set, the training well data set having a set of associated training labels;
dependency-training a backpropagation-enabled process to identify contextual relationships between elements of the training well data set, thereby producing a dependency-trained backpropagation-enabled process;
label-training the dependency-trained backpropagation-enabled process using the training well data set and the associated training labels to assess a training well integrity criterion, thereby producing a label-trained backpropagation-enabled process; and
using the label-trained backpropagation-enabled process to compute a well integrity criterion in a non-training well data set.

2. The method of claim 1, further comprising the step of training the label-trained backpropagation-enabled process by validating and/or correcting the computed well integrity criterion

3. The method of claim 1, wherein the backpropagation-enabled process is a deep learning process.

4. The method of claim 1, wherein the backpropagation-enabled process is a supervised regression process, comprising the step of comparing attributes computed in a conventionally computed technique with the ones from a supervised regression technique.

5. The method of claim 1, wherein the backpropagation-enabled process is selected from the group consisting of supervised processes, semi-supervised processes, and combinations thereof.

6. The method of claim 1, wherein the training well data set is comprised of well data selected from the group consisting of real well data, synthetically generated well data, augmented well data, and combinations thereof.
